(19) United States
(12) Patent Application Publication
(10) Pub. No.: US 2012/0106918 A1
(43) Pub. Date: May 3, 2012

(54) INTERFACE DEVICE AND DATA PROCESSING METHOD

(75) Inventors: Chien-Tsun Chen, New Taipei City (TW); Yi-Lin Zhuo, New Taipei City (TW); Hsin-Hung Lin, New Taipei City (TW)

(73) Assignee: VIA TECHNOLOGIES, INC., New Taipei City (TW)

(21) Appl. No.: 13/226,896

(22) Filed: Sep. 7, 2011

Related U.S. Application Data
(60) Provisional application No. 61/407,473, filed on Oct. 28, 2010.

(30) Foreign Application Priority Data
Apr. 19, 2011 (TW) 100113480

(51) Int. Cl. H04N 5/93; H04N 7/00

(52) U.S. Cl. 386/230; 348/552; 386/E05.028; 348/E07.001

(57) ABSTRACT

An interface device coupled between a computer system and a display system. The interface device includes a control module. The control module receives data from the computer system, and determines whether to display the data on the display system in a projection mode or in a media rendering mode according to operation signals inputted by a user. In the projection mode, the data includes static pictures. The control module projects the static pictures onto the display system in sequence. In the media rendering mode, the data includes a video stream. The control module controls the video stream to be transmitted from the computer system to the display system and controls the playback of the video stream on the display device. When in the projection mode and when the operation signal indicates that switching to the media rendering mode is required, the media rendering mode is activated in the projection mode.

### CROSS REFERENCE TO RELATED APPLICATIONS

This application claims the priority of U.S. Provisional Application No. 61/407,473 filed on Oct. 28, 2010 and the priority of Taiwan Patent Application No. 100113480, filed on Apr. 19, 2011 and the entirety of which is incorporated by reference herein.

### BACKGROUND OF THE INVENTION

1. Field of the Invention

The invention relates to an interface device, and more particularly to an interface device capable of displaying data received from a computer system onto a display system.

2. Description of the Related Art

Integration of multimedia systems with computer systems has become a trend in the home entertainment industry. Conventionally, multimedia systems and computer systems may have separate monitors or display devices. Computer systems, such as a desktop computer or notebook computer, may connect to an LCD (liquid crystal) display device through VGA lines. Multimedia systems like DVD players or cable TVs may connect to a liquid crystal or plasma display device. As a result, a user may need more than one display device to display the contents of multimedia systems and computer systems. Thus, this might be cost inefficient and require more usage of space for the different display devices of different systems.

Currently, one display device can be used to display contents of two or more systems. For example, a TV set-top box connected to a personal computer may display a cable program on the display device of the computer. Thus, it can be said that the TV set-top box, is integrated or plugged-in thereto, as a component of the computer system. However, display quality of the cable program may not be satisfactory due to deterioration in signal quality following signal conversion by the set-top box.

Therefore, in order to increase user convenience and increase signal quality of a multimedia display, a novel apparatus and method for integrating display contents of different systems are highly required.

### BRIEF SUMMARY OF THE INVENTION

An interface device, multimedia playback system and data processing method are provided. An exemplary embodiment of an interface device coupled between a computer system and a display system includes a control module. The control module determines whether to display data received from the computer system on the display system in a projection mode or in a media rendering mode according to an operation signal inputted by a user. In the projection mode, the data includes a plurality of static pictures and the control module projects the static pictures onto the display system in sequence. In the media rendering mode, the data includes a video stream, and the control module controls the video stream to be transmitted from the computer system to the display system and controls the playback of the video stream on the display system. When in the projection mode and when the operation signal indicates that switching to the media rendering mode is required, the media rendering mode is activated in the projection mode.

An exemplary embodiment of a data processing method, wherein data of a computer system is displayed including a video stream and a plurality of static pictures onto a display system via an interface device the data processing method includes: receiving an operation signal inputted by a user; determining whether to display the data on the display system in a projection mode or in a media rendering mode according to the operation signal; in the media rendering mode, transmitting the video stream to the display system for display; and in the projection mode, projecting the static pictures onto the display system in sequence. In the projection mode, when the operation signal indicates that switching to the media rendering mode is required, the media rendering mode is activated in the projection mode, and when the operation signal indicates that switching to the projection mode from the media rendering mode is required, the media rendering mode is terminated and the projection mode is returned.

An exemplary embodiment of a multimedia playback system for displaying data received from a computer system includes a display system for displaying the data and an interface device. The interface device includes a control module. The control module determines whether to display the data on the display system in a projection mode or in a media rendering mode according to an operation signal inputted by a user. In the projection mode, the data includes a plurality of static pictures, and the control module projects the static pictures onto the display system in sequence, and in the media rendering mode, the data includes a video stream, and the control module controls the video stream to be transmitted from the computer system to the display system and controls the playback of the video stream on the display system.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a block diagram of an interface device for integrating a computer system with a display system according to an embodiment of the invention;

FIG. 2 shows a block diagram of an interface device according to an embodiment of the invention;

FIG. 3 shows a block diagram of an interface device according to another embodiment of the invention;

FIG. 4 shows a block diagram of a portion of modules in the computer system 103 according to an embodiment of the invention;

FIG. 5 shows a block diagram of the control module according to an embodiment of the invention;

FIG. 6 is a state machine diagram showing a switching operation between the projection mode and media rendering mode according to an embodiment of the invention;

FIG. 7 is a state machine diagram showing a switching operation between the projection mode and media rendering mode according to another embodiment of the invention; and

FIG. 8 shows a flow chart of a data processing method according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

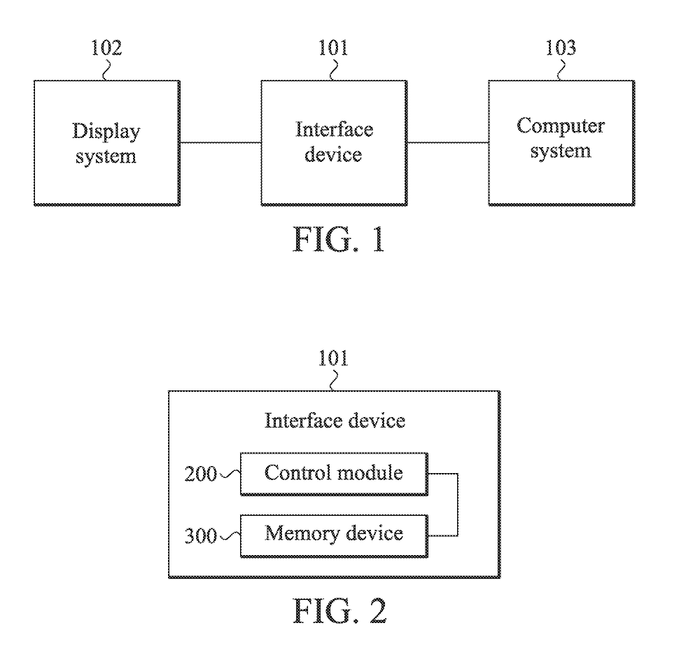

FIG. 1 is a block diagram of an interface device for integrating a computer with a display system according to an embodiment of the invention. The system includes a display system 102, a computer system 103 and an interface device 101 coupled therebetween. According to a concept of the invention, a local area network is formed between the display system 102 and the computer system 103 via the interface device 101. The interface device 101 may be coupled to the display system 102 via a Video Graphics Array (VGA) transmission line or a High-Definition Multimedia Interface (HDMI) transmission line. On the other hand, the interface device 101 may be coupled to the computer system 103 via a wireless network, such as a Wi-Fi (Wireless Fidelity), WiMAX (Worldwide Interoperability for Microwave Access), or an Ethernet. In other embodiments, the interface device 101 may be coupled to the computer system 103 via the Universal Serial Bus (USB). Data transmitted between the computer system 103 and the interface device 101 may adapt to any network protocol, such as a remote frame buffer (RFB).

FIG. 2 shows a block diagram of an interface device according to an embodiment of the invention. The interface device 101 may include at least a control module 200 and a memory device 300. According to an embodiment of the invention, the user may input an operation signal to the computer system 103 via a keyboard, a mouse, or other input device so as to control whether to display of the computer system 103 on the display system 102 in a projection mode or in a media rendering mode. The data of the computer system 103 may include image data, audio data, or any combination thereof. The computer system 103 may generate a selection signal according to the operation signal, and transmit the selection signal and the data to the interface device 101. The memory device 300 may buffer the data, and the control module 200 may determine whether to display data on the display system 102 in the projection mode or in the media rendering mode according to the selection signal. In the projection mode, the data is displayed by projecting a plurality of static pictures in sequence, and in the media rendering mode, the data is displayed by playing a media stream.

In some embodiments of the invention, in the projection mode, the data received from the computer system 103 includes a plurality of static pictures, and may be compressed data or uncompressed data before being transmitted to the interface device 101. For example, in a preferred embodiment, the static pictures may be compressed in the Joint Photographic Experts Group (JPEG) standards, and the transmission rate to transmit the data from the computer system 103 to the interface device 101 is about 30 frames per second. Note that the preferred embodiment does not limit the invention. In one embodiment, data or signal transmissions between the interface device 101 and computer system 103 may adapt to the Universal Plug and Play (UPnP) protocol.

Meanwhile, in the media rendering mode, the data received from the computer system 103 is generally in a format of video stream, and the control module 200 controls the video stream to be transmitted to the display system 102 and controls the playback of the video stream. In a preferred embodiment, the video stream may be encoded/decoded in MPEG-4 (Moving Picture Experts Group) standards, H.264 standards, or others, and the interface device 101 may support UPnP protocol and/or digital media rendering (DMR) technology of the Digital living Network Alliance (DLNA), so as to directly receive the video stream data from the computer system 103 and control the playback of the video stream independently. In other words, the computer system 103 does not have to handle the playback of the video stream, and acts as a server to provide the video stream data to the interface device 101. The playback of the video stream is controlled by the interface device 101 so as to be displayed on the display system 102. In this manner, the video stream can be smoothly played on the display system 102 without delay or lag.

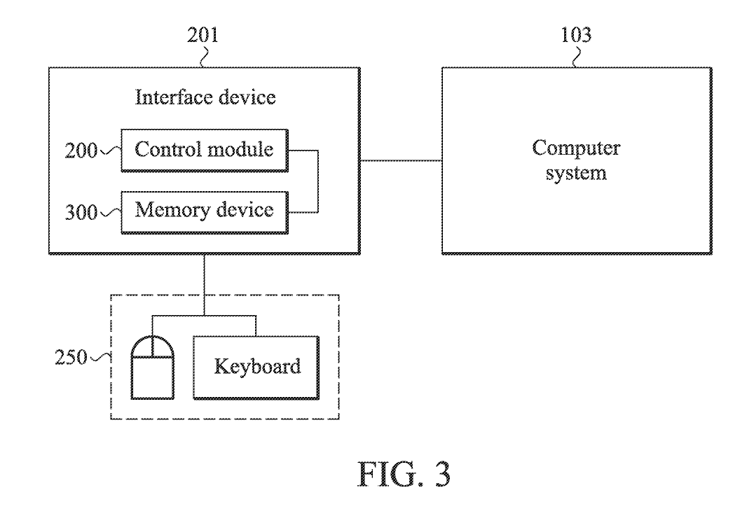

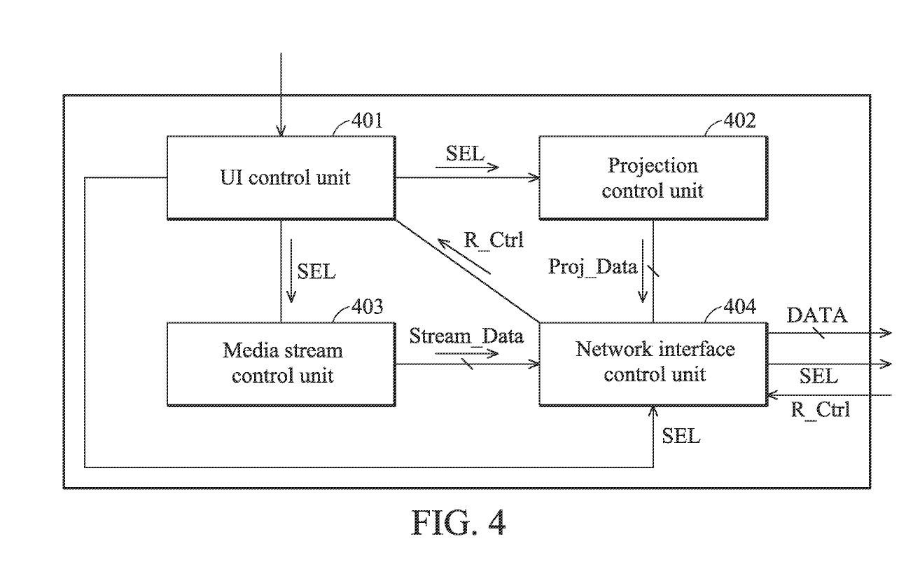

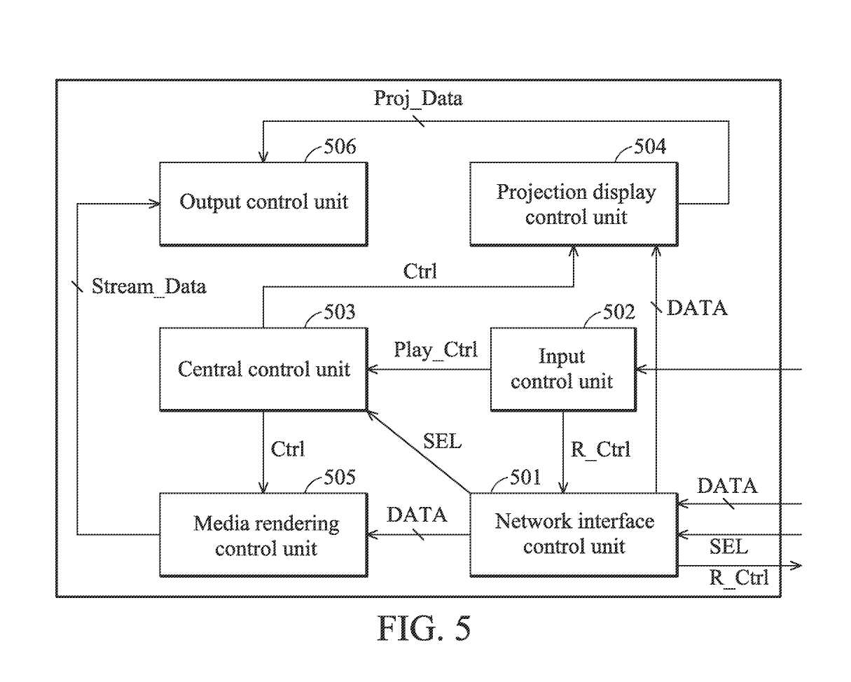

FIG. 3 shows a block diagram of an interface device according to another embodiment of the invention. In the embodiment, the interface device 201 may further include at least an input device 250, which may be a mouse and/or a keyboard coupled to the interface device wirelessly or coupled to the interface device via a USB so as to provide an interface for a user to input the operation signal. The interface device 201 may generate a playback control signal or a remote control signal according to the operation signal. The playback control signal is utilized for controlling the operations in the media rendering mode, and the remote control signal is utilized for controlling the operations in the projection mode. Details of the operations will be illustrated in accompany with FIG. 4 and FIG. 5. For example, in the projection mode, a user may remotely control the computer system 103 via the input device 250, while in the media rendering mode, a user may control the playback of the video stream via the input device 250. Operations and mode switching between the media rendering mode and the projection mode provided by the interface device 101/201 are discussed in more detailed in the following paragraphs.

According to an embodiment of the invention, the computer system 103 does not have to be equipped with a monitor, and may communicate with the display system 102 via the interface device 101/201, and the display system 102 may be a digital TV or other display devices. Therefore, via the interface device 101/201, the computer system 103 may be integrated with the display system 102 into a home entertainment system, which may simultaneously provide the operations of computer and the playback of multimedia data streams.

In one embodiment of the invention, in the projection mode, the interface device 101/201 may project the desktop scenes of the computer system 103 onto the screen of the display system 102. Therefore, in the projection mode, the display system 102 may act as a monitor of the computer system 103, and the computer screen data of the computer system 103 may be extracted from a display card or an output buffer by using a predetermined application, and transmitted to the interface device 101/201 through network.

In addition, the user may operate the computer system 103 by inputting the operation signal via keyboard or mouse of the computer system 103, or via the input device 250 of the interface device 201 as shown in FIG. 3. A user input the operation signals via the input device 250 of the interface device 201 in order to control the computer system 103, the interface device 201 may generate the remote control signal according to the operation signal and transmit the remote control signal to the computer system 103 according to a Remote Desktop Protocol (RDP). In other embodiments, the remote control signal may also be transmitted to the computer system 103 according to other self-defined protocols. The computer system 103 may generate the selection signal according to the remote control signal so as to control the modes of displaying the data of the computer system 103.

According to another embodiment of the invention, in the projection mode, the control module 200 may further determine whether to start a buffering mechanism. When the buffering mechanism begins, the control module 200 may buffer the data in a memory device 300 after receiving the data from the computer system 103, and display the buffered data on the display system 102 after the passing of a predetermined amount of time or after reaching a predetermined data amount which has been buffered in the memory device 300.

According to another embodiment of the invention, the projection mode may further include two sub-modes, including a computer mode and a movie mode. In a normal operation, the computer mode may be activated. When the user would like to play a movie and/or audio/video stream in the computer system 103, the movie mode may be activated. No matter whether in the computer mode or in the movie mode, the data transmitted to the interface device 201 is in a format of static pictures. A user may wish to watch a movie and/or audio/video stream smoothly without delay or lag. When the transmission rate falls behind that of the display rate or when the transmission bandwidth is tight, it brings undesirable experience to the user. Therefore, in the movie mode, the control module 200 may start the buffering mechanism so as to buffer the data received from the computer system 103 in the memory device 300, and display the buffered data on the display system 102 after passing of a predetermined amount of time or after reaching a predetermined data amount which has been buffered in the memory device 300.

In addition to the projection mode, the interface device 101/201 may further operate in the media rendering mode. Similarly, in the media rendering mode, when the video stream data are movies, for example, when a user starts up a Media Player in the Windows operating system to display movies, the control module 200 may start the buffering mechanism so as to buffer the video stream data in the memory device 300, and display the buffered data on the display system 102 after passing of a predetermined amount of time or after reaching a predetermined data amount which has been buffered in the memory device 300.

In the media rendering mode, the computer system 103 only acts as a server, and the computer system 103 does not have to handle or control the playback of the video stream. In one embodiment, after receiving the operation signal, the interface device 101/201 may directly access the video stream data stored in the computer system 103 and control the video stream so that it is displayed on the display system 102. Note that because the file size of the static pictures utilized in the projection mode is usually larger than the video stream data, the video stream may be played on the display system 102 more smoothly without delay or lag as compared with the stream data played in the movie mode of the projection mode. Therefore, the quality of audio/video playback can be improved.

According to an embodiment of the invention, the memory device 300 may be any type of memory and be of any size, and may be partitioned into a plurality of areas for storing data transmitted in the computer mode, in the movie mode and in the media rendering mode, respectively. In this manner, not only will data be smoothly transmitted to the display device 102, the interface device 101/201 may further divide the screen of the display system 102 according to users' requirements, so as to join the static picture data and the video stream data in a picture in picture (PIP) manner for displaying, or further join the static picture data and the video stream data of the computer system 103 and the TV program of the display system 102 received wired or wirelessly for displaying in the PIP manner. Thus, while watching movie and/or TV programs, the user may also operates the computer system 103 through keyboard or mouse of the computer system 103 or the input device 250 of the interface device 101/201.

FIG. 4 shows a block diagram of a portion of modules in the computer system 103 according to an embodiment of the invention. The modules as shown in FIG. 4 may be the application or any software modules, and may be executed by a general processor inside of the computer system 103. As shown in FIG. 4, the application program may be mainly divided into four functional blocks, including a user interface (UI) control unit 401, a projection control unit 402, a media stream control unit 403 and a network interface control unit 404.

The UI control unit 401 is arranged to receive the operation signal inputted by a user, generate a selection signal SEL according to the operation signal, and transmit the selection signal SEL to the projection control unit 402 or the media stream control unit 403 so as to control the modes that display the data of the computer system 103.

The projection control unit 402 is arranged to extract the data to be projected in the projection mode (including the data in the computer mode and/or movie mode) from the display card or output buffer of the computer system 402, to process the projection mode data (including encoding and/or compressing the data), and to transmit the processed projection mode data Proj_Data to the network interface control unit 404. For example, the projection control unit 402 may determine whether to switch from the computer mode to the movie mode according to the selection signal SEL received from the UI control unit 401.

The media stream control unit 403 is arranged to determine whether switching to the media rendering mode is required according to the selection signal SEL received from the UI control unit 401, and to transmit the video stream data Stream Data to the network interface control unit 404 in the media rendering mode. For example, the media stream control unit 403 may use the built-in DMR of the Media Player in the Windows operating system to directly send out the video stream data Stream_Data.

The network interface control unit 404 is arranged to convert the received data Proj_Data or the Stream_Data and the selection signal SEL to a format capable of being transmitted in the internet (the Ethernet or wireless network) or the USB port, and then send out. The label DATA represents the sent out data of Proj_Data or Stream_Data. In another embodiment, the network interface control unit 404 is further arranged to receive the remote control signal R_Ctrl from the interface device 101/201, and transmit the remote control signal R_Ctrl to the UI control unit 401, so that the interface device 101/201 may remotely control the computer system 103 via the remote control signal R_Ctrl, including determining the mode in which to display the data of the computer system 103, and others. In one embodiment, the network interface control unit 404 may transmit the data DATA and selection signal SEL to the interface device 101/201 and receive the remote control signal R_Ctrl therefrom through the wireless network according to the UPnP network protocol.

FIG. 5 shows a block diagram of the control module 200 according to an embodiment of the invention. As show in FIG. 5, the control module may include six control units, including a network interface control unit 501, an input control unit 502, a central control unit 503, a projection display control unit 504, a media rendering control unit 505 and an output control unit 506. Note that the control units as shown may be implemented by software, firmware, hardware, or any combination thereof, and the invention should not be limited thereto.

The network interface control unit 501 may corresponds to the network interface control unit 404 of the computer system 103 as shown in FIG. 4, and is arranged to receive the data DATA and selection signal SEL from the network interface control unit 404. The network interface control unit 501 may further be arranged to convert the selection SEL and data DATA back to their original formats. In one embodiment, the data DATA may be the projection data Proj_Data in the projection mode, the video stream data Stream_Data in the media rendering mode, or a combination thereof. Next, the network interface control unit 501 may transmit the selection signal SEL to the central control unit 503, and transmit the data DATA to the projection display control unit 504 and the media rendering control unit 505. The projection display control unit 504 may process the projection data Proj_Data, and the media rendering control unit 505 may process the video stream data Stream_Data. In one embodiment, the projection display control unit 504 may by pass the video stream data Stream_Data when receiving the video stream data Stream_Data, and similarly, the media rendering control unit 505 may ignore the projection data Proj_Data when receiving the projection data Proj_Data.

The input control unit 502 is arranged to receive the operation signal inputted by the user from the input device 250, and accordingly generate a playback control signal Play_Ctrl and transmit the playback control signal Play_Ctrl to the central control unit 503, or accordingly generate a remote control signal R_Ctrl and transmit the remote control signal R_Ctrl to the network interface control unit 501, which is further transmitted to the computer system 103 for controlling the computer system 103 remotely.

The central control unit 503 may generate a control signal Ctrl according to the playback control signal Play_Ctrl received from the input control unit 502 or according to the selection signal SEL received from the network interface control unit 501. The control signal Ctrl may be transmitted from the central control unit 503 to the projection display control unit 504 and the media rendering control unit 505, respectively, so as to control the operations thereof, including switching between different modes (which will be discussed in the following paragraphs).

The projection display control unit 504 is arranged to control the operations of the interface device 101/201 in the projection mode. The media rendering control unit 505 is arranged to control the operations of the interface device 101/201 in the media rendering mode. The operations include determining compress/decompress and/or encoding/decoding formats, compressing/decompressing and/or encoding/decoding the projection data Proj_Data or the video stream data Stream_Data, determining whether to start the buffering mechanism according to the control signal Ctrl, and handling other processes according to the control signal Ctrl.

The output control unit 506 is arranged to receive the processed data from the projection display control unit 504 and media rendering control unit 505, including the projection data Proj_Data and the video stream data Stream_Data, and transmit the processed projection data Proj_Data and the video stream data Stream_Data to the display system 102. Note that the compression/decompression module and encoder/decoder in the projection display control unit 504 and media rendering control unit 505 may also be integrated in the output control unit 506. In other words, compressing/decompressing and/or encoding/decoding of the data (including the projection data Proj_Data and the video stream data Stream_Data) may all be executed by the output control unit 506.

According to an embodiment of the invention, the interface device 101/201 may be implemented as a System-on-a-chip (SoC), and may be integrated in the display system 102. When the interface device is integrated in the display system 102, the HDMI or VGA transmission line connected therebetween is not required.

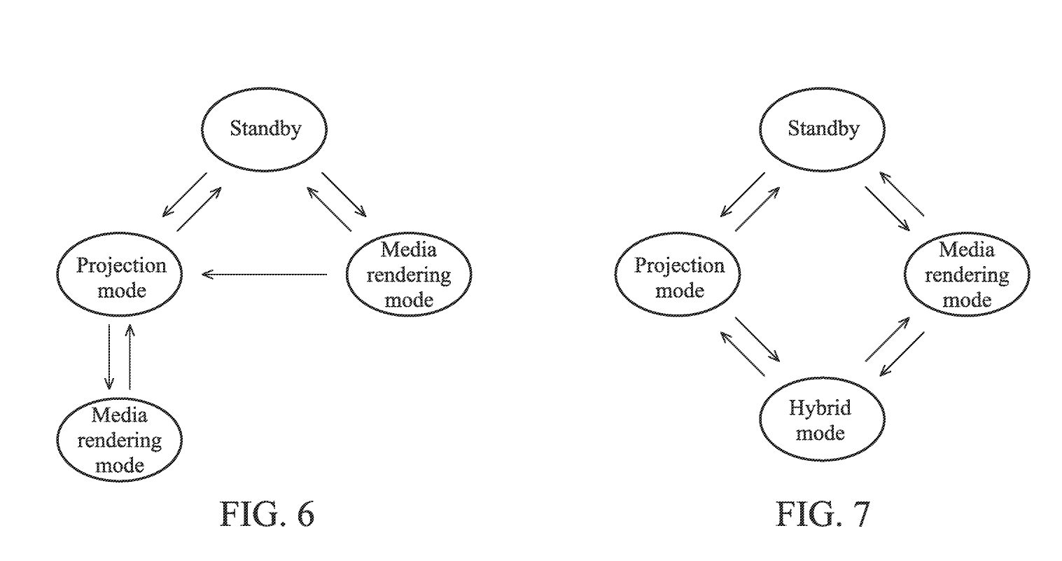

FIG. 6 is a state machine diagram showing a switching operation of the projection mode and media rendering mode according to an embodiment of the invention. Before receiving the operation signal (or selection signal), the interface device 101/201 stays in the standby state. After receiving the operation signal (or selection signal), the interface device 101/201 may switch to the projection mode or the media rendering mode according to the operation signal or selection signal. In one embodiment, in the media rendering mode, when the operation signal (or the selection signal) indicates that the user would like to switch the system from the media rendering mode to the projection mode, the central control unit 503 directly switches from the media rendering mode state to the projection mode state. Note that in the projection mode, when the operation signal (or the selection signal) indicates that the user would like to switch the system from the projection mode to the media rendering mode, the central control unit 503 may directly activate the media rendering mode in the projection mode, instead of switching from the projection mode state to the media rendering mode state. Therefore, when the user would like to exit the media rendering mode, for example, when the input control unit 502 receives the operation signal indicating that the user wants to stop playing the media stream, the central control unit 503 terminates rendering of the media stream and returns back to the projection mode.

FIG. 7 is a state machine diagram showing a switching operation of the projection mode and media rendering mode according to another embodiment of the invention. Before receiving the operation signal (or selection signal), the interface device 101/201 stays in the standby state. After receiving the operation signal (or selection signal), the interface device 101/201 may switch to the projection mode or the media rendering mode according to the operation signal or selection signal. Note that when the operation signal (or the selection signal) indicates that the user would like to activate both the projection and media rendering functions, the central control unit 503 controls the system to switch from the original projection mode state or media rendering mode state to a hybrid mode state. In the hybrid mode, the projection data Proj_Data and the media stream data Stream_Data are simultaneously displayed on the display system 102 by a picture in picture (PIP) manner. When the user would like to terminate the PIP screen, the central control unit 503 may control the system to return back to the original projection mode state or media rendering mode state.

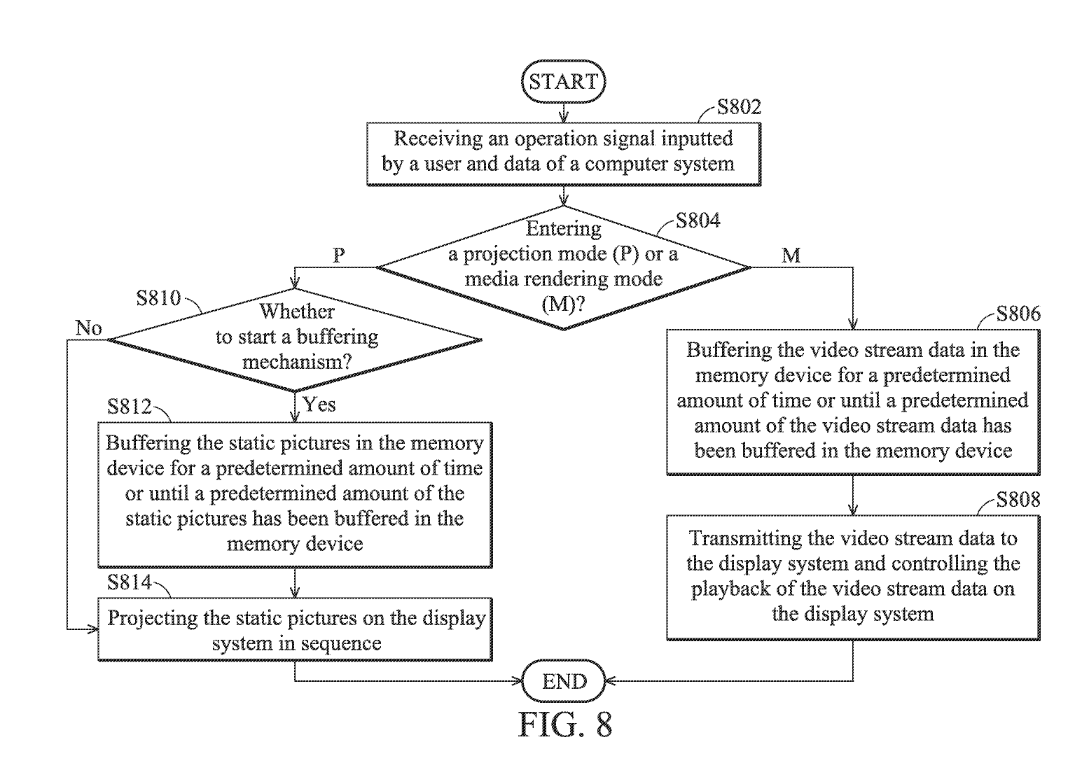

FIG. 8 shows a flow chart of a data processing method according to an embodiment of the invention. The data processing method may process the data of a computer system to be displayed on a display system, wherein the display system may include a television or other monitor. Firstly, an operation signal inputted by a user and data of the computer system are received (Step S802). Next, whether to display the data on the display system in a projection mode (P) or in a media rendering mode (M) is determined according to the data or the operation signal (Step S804). In one embodiment, the user may input the operation signal via the input device (for example, the keyboard or mouse) of the computer system or the input device of the interface device, so as to indicate which mode is utilized for displaying the data of the computer system. Next, in the media rendering mode (M), a buffering mechanism is started, so as to buffer the data (for example, the video stream data) received from the computer system in the memory device, until passing of a predetermined amount of time or until a predetermined amount of the video stream data has been buffered in the memory device (Step S806). Next, the video stream data is transmitted to the display system, and the playback of the video stream data on the display system is controlled by the control module (Step S808). On the other hand, in the projection mode (P), it is further determined whether to start the buffering mechanism (Step S810). When the buffering mechanism is started, the data received from the computer system, for example, the static pictures extracted from the computer screen of the computer system, is buffered in the memory device for a predetermined amount of time or until a predetermined amount of the static pictures has been buffered in the memory device (Step S812). Next, the static pictures are projected on the display system in sequence (Step S814). When the buffering mechanism is not started, step S814 can be directly executed.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An interface device coupled between a computer system and a display system, comprising:
a control module, determining whether to display data received from the computer system on the display system in a projection mode or in a media rendering mode according to an operation signal inputted by a user,
wherein in the projection mode, the data comprises a plurality of static pictures, and the control module projects the static pictures onto the display system in sequence, and
wherein in the media rendering mode, the data comprises a video stream, and the control module controls the video stream to be transmitted from the computer system to the display system and controls the playback of the video stream on the display system,
wherein when in the projection mode and when the operation signal indicates that switching to the media rendering mode is required, the media rendering mode is activated in the projection mode.

2. The interface device as claimed in claim 1, wherein when the operation signal indicates that switching to the projection mode from the media rendering mode is required, the media rendering mode is terminated and the projection mode is returned.

3. The interface device as claimed in claim 1, wherein before displaying the data on the display system, the control module further starts a buffering mechanism to buffer the data in a memory device, and displays the buffered data on the display system when one of two criteria is satisfied.

4. The interface device as claimed in claim 3, wherein the two criteria comprise passing of a predetermined amount of time and reaching a predetermined data amount which has been buffered in the memory device.

5. The interface device as claimed in claim 3, wherein in the projection mode, the control module further determines whether to start the buffering mechanism according to the operation signal.

6. The interface device as claimed in claim 1, further comprising:
at least an input device, receiving the operation signal and generating a remote control signal or a playback control signal according to the operation signal,
wherein in the projection mode, the control module further transmits the remote control signal to the computer system so as to remotely control the computer system, and in the media rendering mode, the control module further controls the playback of the video stream according to the playback control signal.

7. The interface device as claimed in claim 1, wherein in the projection mode or in the media rending mode, the control module further determines whether to enter a hybrid mode according to the operation signal, and if determined, in the hybrid mode, the control module simultaneously receives both of the static pictures and the video stream, and displays the static pictures and the video stream on the display system by a picture in picture (PIP) manner.

8. The interface device as claimed in claim 1, wherein the static pictures are compressed in the Joint Photographic Experts Group (JPEG) standards, and the video stream is encoded/decoded in the Moving Picture Experts Group (MPEG) standards.

9. The interface device as claimed in claim 1, wherein the operation signal is inputted by the user via the computer system and the computer system transmits the operation signal and the data to the control module.

10. The interface device as claimed in claim 9, wherein the control module receives the operation signal and the data from the computer system via a wireless network, an Ethernet or a Universal Serial Bus (USB).

11. A data processing method, wherein data of a computer system is displayed on a display system via an interface device, and the data comprises a video stream and a plurality of static pictures, the data processing method comprising:
receiving an operation signal inputted by a user;
determining whether to display the data on the display system in a projection mode or in a media rendering mode according to the operation signal;
in the media rendering mode, transmitting the video stream to the display system for displaying; and
in the projection mode, projecting the static pictures onto the display system in sequence,
wherein in the projection mode, when the operation signal indicates that switching to the media rendering mode is required, the media rendering mode is activated in the projection mode, and when the operation signal indicates that switching to the projection mode from the media rendering mode is required, the media rendering mode is terminated and the projection mode is returned.

12. The method as claimed in claim 11, further comprising:
buffering the data in a memory device before displaying thereof on the display system; and
displaying the buffered data on the display system when one of two criteria is satisfied.

13. The method as claimed in claim 12, wherein the criteria comprises:
passing of a predetermined amount of time; and
reaching a predetermined data amount which has been buffered in the memory device.

14. The method as claimed in claim 12, further comprising:
in the project mode, determining whether to buffer the static pictures in the memory device according to the operation signal.

15. The method as claimed in claim 11, further comprising:
in the projection mode, receiving the operation signal via an input device of the interface device, and generating a remote control signal according to the operation signal; and
transmitting the remote control signal to the computer system so as to remotely control the computer system.

16. The method as claimed in claim 11, further comprising:
in the media rendering mode, receiving the operation signal via an input device of the interface device, and generating a playback control signal according to the operation signal; and
controlling the playback of the video stream according to the playback control signal.

17. The method as claimed in claim 11, further comprising:
determining whether to enter a hybrid mode according to the operation signal; and
if entering the hybrid mode is determined, in the hybrid mode, displaying the static pictures and the video stream on the display system by a picture in picture (PIP) manner.

18. The method as claimed in claim 17, further comprising:
determining whether to return back to the projection mode or in the media rendering mode according to the operation signal after switching to the hybrid mode; and
when the hybrid mode is switched to from the project mode, returning back to the projection mode, and
when the hybrid mode is switched to from the media rendering mode, returning back to the media rendering mode.

19. The method as claimed in claim 11, wherein the operation signal is inputted by the user via the computer system.

20. A multimedia playback system for displaying data received from a computer system, comprising:
a display system, displaying the data; and
an interface device, comprising:
a control module, determining whether to display the data on the display system in a projection mode or in a media rendering mode according to an operation signal inputted by a user,
wherein in the projection mode, the data comprises a plurality of static pictures, and the control module projects the static pictures onto the display system in sequence, and
wherein in the media rendering mode, the data comprises a video stream, and the control module controls the video stream to be transmitted from the computer system to the display system and controls the playback of the video stream on the display system,
wherein when in the projection mode and when the operation signal indicates that switching to the media rendering mode is required, the media rendering mode is activated in the projection mode.
